(19) United States
(12) Patent Application Publication
(10) Pub. No.: US 2012/0098732 A1
(43) Pub. Date: Apr. 26, 2012

(54) EMI DETECTION APPARATUS

(75) Inventors: ZE-LIANG XIE, Shenzhen City (CN); SHI-XUAN FENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/917,410

(22) Filed: Nov. 1, 2010

(30) Foreign Application Priority Data
Oct. 20, 2010 (CN) 201010512913.3

(51) Int. Cl. H01Q 1/10

(52) U.S. Cl. 343/901

(57) ABSTRACT

An electromagnetic interference (EMI) detection apparatus includes a telescopic antenna and a detecting element. The telescopic antenna includes an antenna body and an adapter portion. The antenna body is rotatably mounted on the adapter portion. The adapter portion includes a connecting portion electrically connected to the antenna body.

The detecting element includes a main body, a cable, and a probe. The main body includes a matching portion. The matching portion is electrically connected to the connecting portion of the adapter portion. A first terminal of the cable is electrically connected to the matching portion. A second terminal of the cable is electrically connected to the probe. This EMI detecting apparatus ,cooperating with hybrid biconical/log periodic antenna and spectrum analyzer, can detect the root cause of EMI conveniently.

### BACKGROUND

1. Technical Field

The present disclosure relates to an apparatus for detecting electromagnetic interference (EMI).

2. Description of Related Art

Electronic devices normally need to be tested for EMI before reaching the market. However, many detection apparatuses may experience EMI from surrounding devices, resulting in inaccurate results. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of an electromagnetic interference (EMI) detection apparatus.

FIG. 2 is an assembled, isometric view of the EMI detection apparatus of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

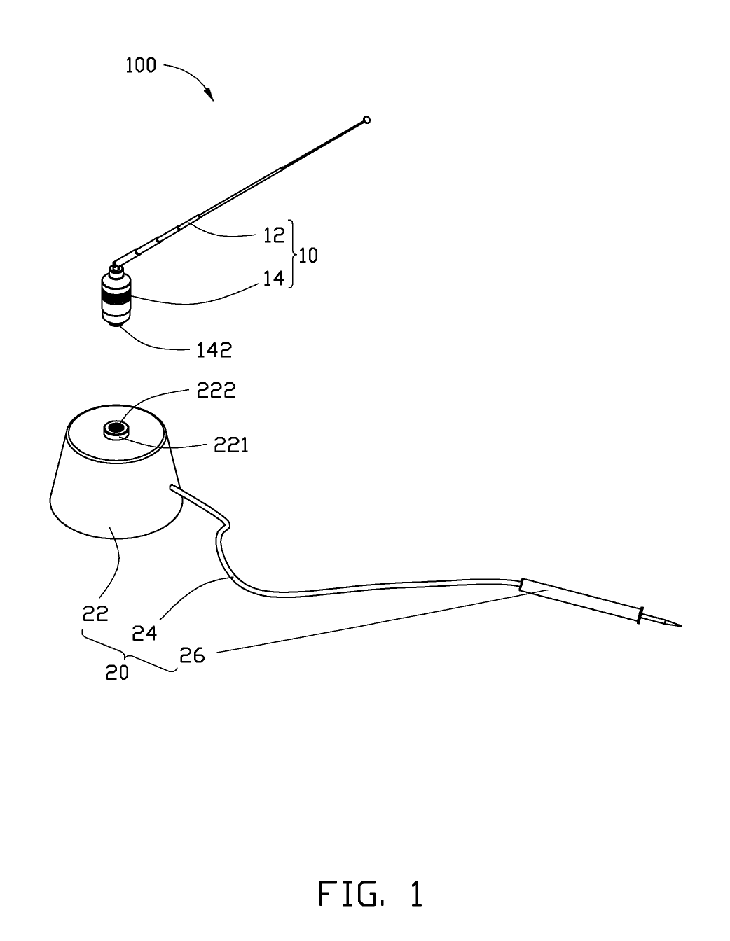

Referring to FIG. 1, an embodiment of an electromagnetic interference (EMI) detection apparatus 100 includes a telescopic antenna 10 and a detecting element 20.

The antenna 10 includes an antenna body 12 and an adapter portion 14. The antenna body 12 is rotatably mounted on the adapter portion 14. The adapter portion 14 includes a threaded post 142 extending from the bottom of the adapter portion 14, opposite to the antenna body 12. The threaded post 142 is electrically connected to the antenna body 12.

The detecting element 20 includes a main body 22, a cable 24, and a probe 26. In one embodiment, the main body 22 is truncated cone-shaped. In other embodiments, the shape of the main body 22 can be designed to other different shapes, such as cuboid. A post-shaped conductive member 221 is embedded in the main body 22, and exposed through a top of the main body 22. The conductive member 221 axially defines a threaded hole 222, corresponding to the threaded post 142. A first terminal of the cable 24 extends through the main body 22 and is electrically connected to the conductive member 221, a second terminal of the cable 24 is electrically connected to the probe 26. In other embodiments, the threaded post 142 can present other connecting portions, with the conductive member 221 with the threaded hole 222 corresponding thereto.

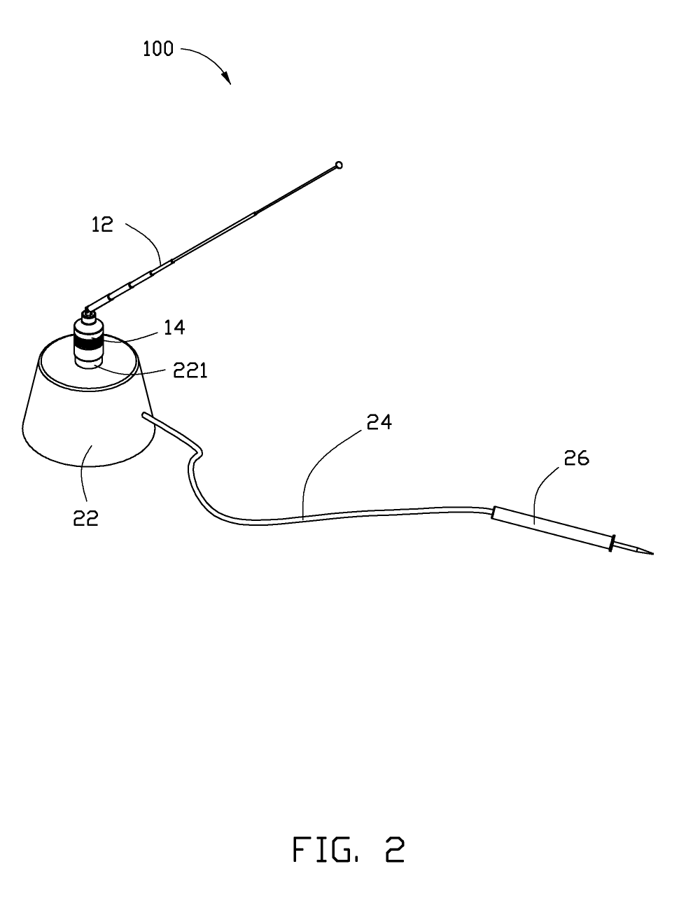

Referring to FIG. 2, in assembly, the antenna 10 is connected to the conductive member 221 of the main body 22 through the threaded post 142 received in the threaded hole 222. At this time, the antenna body 12 is electrically connected to the probe 26.

Before using the EMI detection apparatus 100 to detect EMI of an electrical device, such as a motherboard (not shown), frequencies to be tested for are obtained according to requirements. According to the formula between frequency and wavelength: λk=C/V, where 2 stands for wavelength of electromagnetic wave, C stands for a speed of light, and V stands for a frequency of the electromagnetic, a plurality of wavelengths corresponding to the frequencies can be calculated.

During detection, a common hybrid biconical/log periodic antenna together with a spectrum analyzer (not shown) is required. The hybrid biconical/log periodic antenna and the spectrum analyzer fall within well-known technologies, and are therefore not described here.

When testing for one of the frequencies, the main body 22 of the EMI detection apparatus 100 is positioned adjacent to the electrical device, and strength of the antenna body 12 is adjusted to equal a quarter of the wavelength corresponding to the detected frequency, and the direction of the antenna body 12 is adjusted to match the direction of the hybrid biconical/log periodic antenna. After the adjustment, the probe 26 contacts a plurality of detecting points, such as pins of chips, in the electrical device. The antenna body 12 receives high-frequency current from the probe 26, and generates resonance to emit corresponding electromagnetic wave. The hybrid biconical/log periodic antenna receives the electromagnetic wave emitted from the antenna body 12, and displays the wave through the spectrum analyzer. The telescopic antenna 10 is used to receive EMI and emit corresponding electromagnetic waves to the hybrid biconical/log periodic antenna to increase detection sensitivity, ensuring accurate results for the electrical device testing.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An electromagnetic interference (EMI) detection apparatus comprising:
a telescopic antenna comprising an antenna body and an adapter portion, the antenna body rotatably mounted to the adapter portion, the adapter portion comprising a connecting portion, the connecting portion electrically connected to the antenna body; and
a detecting element comprising a main body, a cable, and a probe;
wherein the main body comprises a matching portion arranged on the main body, the matching portion is electrically connected to the connecting portion of the adapter portion, a first terminal of the cable is electrically connected to the matching portion, a second terminal of the cable is electrically connected to the probe.

2. The EMI detection apparatus of claim 1, wherein the connecting portion is a threaded post, the matching portion is a threaded hole defined in the main body of the detecting element, corresponding to the threaded post.

3. The EMI detection apparatus of claim 1, wherein the main body is truncated cone-shaped.
